(19) United States
(12) Patent Application Publication
(10) Pub. No.: US 2023/0326147 A1
(43) Pub. Date: Oct. 12, 2023

(54) HELPER DATA FOR ANCHORS IN AUGMENTED REALITY

(71) Applicant: InterDigital CE Patent Holdings, SAS, Paris (FR)

(72) Inventors: Pierrick Jouet, Rennes (FR); Caroline Baillard, Saint Sulpice La Forest (FR); Matthieu Fradet, Chanteloup (FR); Anthony Laurent, Vignoc (FR)

(21) Appl. No.: 18/017,231

(22) PCT Filed: Jul. 6, 2021
(86) PCT No.: PCT/EP2021/068640

§ 371 Date: Jan. 20, 2023

(30) Foreign Application Priority Data
Jul. 21, 2020 (EP) 20305836.7

(51) Int. Cl. G06T 7/11; G06T 17/20; G06T 19/00; G06T 7/73

(52) U.S. Cl. CPC G06T 19/006; G06T 7/11; G06T 7/74; G06T 17/20; G06T 2207/20132; G06T 2207/30204

(57) ABSTRACT

In an augmented reality system, helper data are associated to augmented reality anchors to describe the surroundings of the anchor in the real environment. This allows to verify that positional tracking is correct, in other words, that an augmented reality terminal is localized at the right place in an augmented reality scene. This helper data may be shown on request. Typical examples of helper data are a cropped 2D image or a 3D mesh.

### TECHNICAL FIELD

At least one of the present embodiments generally relates to augmented reality and more particularly to the anchors used for positioning in a virtual environment.

### BACKGROUND

Augmented reality (AR) is a concept and a set of technologies for merging real and virtual elements to produce visualizations where physical and digital objects co-exist and interact in real time. AR visualizations require a means to see augmented virtual elements as a part of the physical view. This can be implemented using an augmented reality terminal (AR terminal) equipped with a camera and a display, which captures video from the user’s environment and combines this captured information with virtual elements on a display. Examples of such devices are such as smartphones, tablets or head-mounted displays. 3D models and animations are the most obvious virtual elements to be visualized in AR. However, AR objects can more generally be any digital information for which spatiality (3D position and orientation in space) gives added value, for example pictures, videos, graphics, text, and audio. AR visualizations can be seen correctly from different viewpoints, so that when a user changes his/her viewpoint, virtual elements stay or act as if they would be part of the physical scene. This requires tracking technologies for deriving 3D properties of the environment to produce AR content, and when viewing the content, for tracking the position of the AR terminal with respect to the environment. The AR terminal’s position can be tracked, for example by tracking known objects or visual features in the AR terminal’s video stream and/or using one or more sensors. Before the AR objects can be augmented into physical reality, their positions must be defined with respect to the physical environment. A particular challenge of augmented reality is when multiple users access the same AR scene and thus can interact together though this virtual environment. A precise and reliable positioning of AR terminals is a critical aspect of an AR system since such feature is mandatory to enjoy the AR experience.

### SUMMARY

In at least one embodiment, in an augmented reality system, helper data are associated to augmented reality anchors to describe the surroundings of the anchor in the real environment. This allows to verify that positional tracking is correct, in other words, that an augmented reality terminal is localized at the right place in an augmented reality scene. This helper data may be shown on request. Typical examples of helper data are a cropped 2D image or a 3D mesh.

A first aspect of at least one embodiment is directed to a method for creating an anchor for an augmented reality scene comprising displaying feature points detected while displaying an augmented reality scene, obtaining the selection of at least one feature point, capturing helper data, and creating a new anchor and associate to it parameters of the selected at least one feature point and the captured helper data.

A second aspect of at least one embodiment is directed to a method for displaying an augmented reality scene on an augmented reality terminal comprising, when the display of helper data is activated and an augmented reality anchor is detected, obtaining a helper data associated to the detected augmented reality anchor and displaying a graphical representation of the helper data.

A third aspect of at least one embodiment is directed to a method for verifying an augmented reality anchor in an augmented reality scene on an augmented reality terminal, the method comprising determining an augmented reality anchor corresponding to at least one feature point detected while displaying an augmented reality scene, obtaining helper data associated to the detected augmented reality anchor, obtaining captured data representative of a real-world scene, comparing the helper data to the captured data and responsively triggering a recovery.

A fourth aspect of at least one embodiment is directed to an apparatus for creating an anchor for an augmented reality scene comprising a processor configured to display feature points detected while displaying an augmented reality scene, obtain the selection of at least one feature point, capture helper data, and create a new anchor and associate to it parameters of the selected at least one feature point and the captured helper data.

A fifth aspect of at least one embodiment is directed to an apparatus for displaying an augmented reality scene on an augmented reality terminal comprising a processor configured to, when the display of helper data is activated and an augmented reality anchor is detected, obtain a helper data associated to the detected augmented reality anchor and display a graphical representation of the helper data.

A sixth aspect of at least one embodiment is directed to an apparatus for verifying an augmented reality anchor in an augmented reality scene on an augmented reality terminal, the apparatus comprising a processor configured to determine an augmented reality anchor corresponding to at least one feature point detected while displaying an augmented reality scene, obtain helper data associated to the detected augmented reality anchor, obtain captured data representative of a real-world scene, compare the helper data to the captured data and responsively trigger a recovery.

A seventh aspect of at least one embodiment is directed to an augmented reality system comprising an augmented reality scene, an augmented reality controller and an augmented reality terminal, wherein the augmented reality scene comprises an augmented reality anchor associated to parameters of a feature point of a representation of the augmented reality scene and helper data representative of surrounding of the augmented reality anchor.

According to variants of these seven embodiments, the helper data is based on a picture captured when creating the anchor, or is a cropped version of the picture captured when creating the anchor or is based on a three-dimensional mesh captured when creating the anchor.

According to an eighth aspect of at least one embodiment, a computer program comprising program code instructions executable for implementing at least the steps of a method according to one of the first three aspects when executed by a processor.

According to a ninth aspect of at least one embodiment, a non-transitory computer readable medium comprises program code instructions executable for implementing at least the steps of a method according to one of the first three aspects when executed by a processor.

### BRIEF DESCRIPTION OF THE DRAWINGS

FIG. 1 illustrates a block diagram of an example of an augmented reality system in which various aspects and embodiments are implemented.

FIGS. 2A, 2B, 2C illustrate an example of usage of an AR scene with two users.

FIG. 3 illustrates an example flowchart of a user-operated verification process according to at least one embodiment.

FIG. 4 illustrates an example flowchart of process for the creation of an anchor according to at least one embodiment.

FIGS. 5A to 5F illustrate various examples of screens displayed by an AR terminal according to the verification process 300.

FIGS. 6A, 6B, 6C illustrate various examples of screens displayed by an AR terminal according to the anchor creation process 400.

FIG. 7 illustrates an example flowchart of an automated verification process according to at least one embodiment.

FIG. 8 illustrates a block diagram of an example implementation of augmented reality terminal according to an embodiment.

FIG. 9 illustrates a block diagram of an example implementation of augmented reality controller according to an embodiment.

FIG. 10 illustrates a sequence diagram of an anchor creation according to at least one embodiment.

FIG. 11 illustrates a sequence diagram of a manual verification according to at least one embodiment.

### DETAILED DESCRIPTION

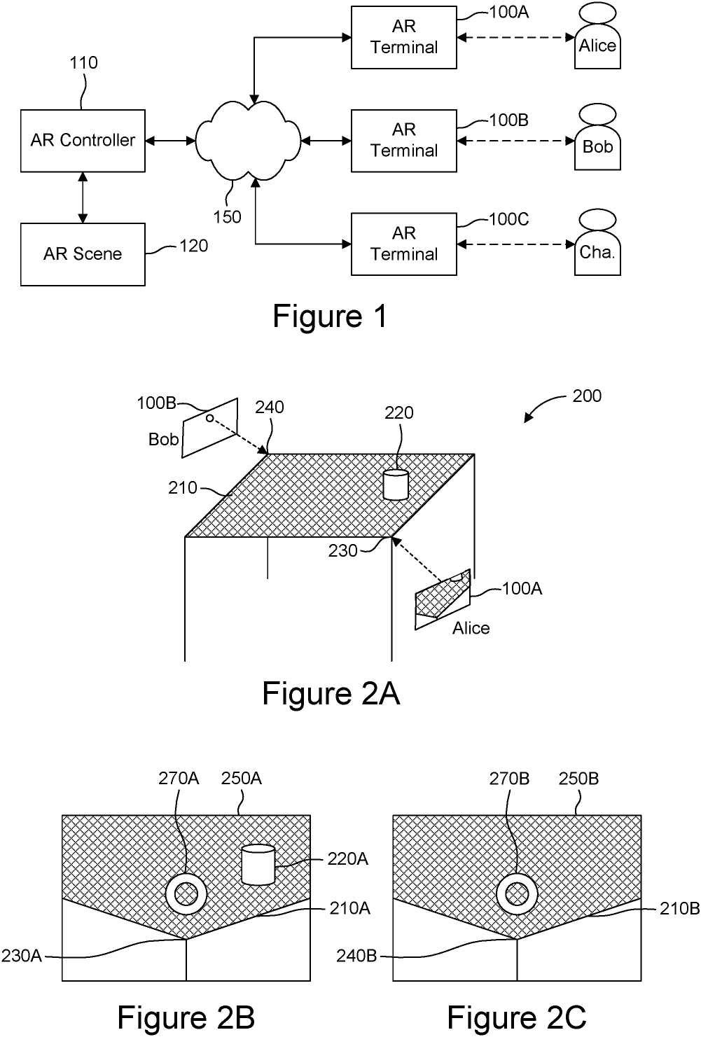

FIG. 1 illustrates a block diagram of an example of a system in which various aspects and embodiments are implemented. Such system is designed to allow shared (i.e. collaborative) augmented reality experience which is the next challenge for AR applications. Multiple users — here Alice, Bob and Charlie — can simultaneously view and interact with virtual objects from their position in an AR scene which is a shared augmented scene taking place in a real-world 3D environment. Modifications in the AR scene can be visible in real time to every user. A digital representation of the AR scene 120 is handled by an AR controller 110 that manages also the coordination of the interactions between users in the virtual environment. To enjoy the AR scene, users will join other users in the shared augmented space using an AR terminal (100A, 100B, 100C). The AR terminal displays the virtual objects of the AR scene superimposed to the view of the real-world environment. To ensure consistent interactions with the AR scene, all AR terminals must be continuously localized in the same world frame coordinate system. AR terminals and the AR controller are coupled together through a communication network 150. This network is preferably wireless to provide mobility to the AR terminals.

In a collaborative experience using the system of FIG. 1, the virtual objects are shared between all the users. Each user may use his own AR terminal to display the AR scene. Each user may be associated with an AR proxy that represents the user in the virtual environment. The position of the AR proxy is associated to the position of the AR terminal of the user. The AR proxy may take the form of a human-looking 3D model or any other virtual object. The users will move into the AR scene, interact with virtual objects of the shared AR scene or interact with other users through their AR proxy. For example, when Alice moves to the right, the AR terminal 100A will be moved to the right and thus the position of the corresponding AR proxy within the AR scene will be updated by the AR controller 110 and will be provided to the other AR terminals 100B and 100C to be reflected into these devices that Bob and Charlie can visualize the move of Alice. Stability is essential to the overall success of the experience and more particularly regarding the positioning of the different AR terminals and tracking of their movements.

Defining the position and orientation of a real object in space is known as positional tracking and may be determined with the help of sensors. Sensors record the signal from the real object when it moves or is moved, and the corresponding information is analyzed with regards to the overall real environment to determine the position. Different mechanisms can be used for the positional tracking of an AR terminal including wireless tracking, optical tracking with or without markers, inertial tracking, sensor fusion, acoustic tracking, etc.

In consumer environments, optical tracking is one of the technique conventionally used for positional tracking. Indeed, typical augmented reality capable devices such as smartphones, tablets or head-mounted displays comprise a camera able to provide images of the scene facing the device. Some AR systems use visible markers like QR codes physically printed and positioned at a known location both in the real scene and in the AR scene, thus enabling to perform a correspondence between virtual and real worlds when detecting these QR codes.

Less intrusive markerless AR systems may use a two step approach were the AR scene is first modeled to enable the positioning in a second step. The modeling may be done for example through a capture of a real environment. Feature points are detected from the captured data corresponding to the real environment. A feature point is a trackable 3D point so it is mandatory that it can be differentiated from its closest points in the current image. With this requirement, it is possible to match it uniquely with a corresponding point in a video sequence corresponding to the captured environment. Therefore, the neighborhood of a feature should be sufficiently different from the neighborhoods obtained after a small displacement. Usually, it is high frequency point like a corner. Typical examples of such points are a corner of a table, the junction between the floor and the wall, a knob on a furniture equipment, the border of a frame on a wall, etc. An AR scene also be modeled instead of captured. In this case, anchors are associated to selected distinctive points in the virtual environment. Then, when using such AR system, the captured image from an AR terminal is continuously analyzed to recognize the previously determined distinctive points and thus make the correspondence with their position in the virtual environment allowing thus to determine the position of the AR terminal.

In addition, some AR systems combines the 2D feature points of captured image with depth information for example obtained through a time-of-flight sensor or with motion information for example obtained from accelerometers, gyroscopes or inertial measurement units based on micromechanical systems.

According to the system described in FIG. 1, this analysis may be done fully in the AR terminals, fully done in the AR controller or the computations may be shared between these devices. Indeed, the detection of the distinctive point corresponds, in general, to the detection of feature points in a 2D image, for example using SIFT descriptor to identify the feature points. This can be quite resource consuming task, especially for mobile devices when the battery charge is limited. Therefore, AR systems may balance the computation workload by performing some of the computations in the AR controller, that is typically a computer or server. This requires transmitting the information gathered from the AR terminal sensor to the AR controller and the complete computation time must not exceed the duration between the display of two consecutive frames. This step includes the data transmission to the server and the computation result retrieval. Such solution is only possible for networks with low latency.

In order to minimize the positional tracking computation workload, some AR systems use a subset of selected feature points named anchors. While a typical virtual environment may comprise hundreds or thousands of feature points, anchors are generally predetermined within the AR scene, for example manually selected when building the AR scene. A typical AR scene may comprise around half a dozen of anchors, therefore minimizing the computation resources required for the positional tracking. An anchor is a virtual object defined by a pose (position and a rotation) in a world frame. An anchor is associated with a set of features points that define a unique signature. The anchor position is consequently very stable and robust. When an anchor has been placed in a zone of an AR scene, the visualization of said zone when captured by the camera of an AR terminal will lead to an update of the localization. This is done in order to correct any drifts. In addition, virtual objects of an AR scene are generally attached to anchors to secure their spatial position in the world frame.

Anchors may be defined using ray casting. Feature points are displayed as virtual 3D particles. The user will make sure to select an object belonging to a dense set, this will give a stronger signature to the area. The pose of the feature point hit by the ray will give the pose of the anchor.

FIGS. 2A, 2B, 2C illustrate an example of usage of an AR scene with two users. The AR scene, the situation described, and the corresponding drawings are obviously very simplified examples. As shown in FIG. 1A, Alice and Bob are in the same room 200 that is equipped with a table 210 on which a mug 220 is positioned near one of the corners. The environment corresponds to an AR Scene, shared between both AR terminals. Alice and Bob manipulate their respective AR terminals 100A and 100B and visualize the AR scene through the screen of their devices. Alice points the AR terminal 100A in direction of the table 200, looking at the corner 230 of the table. Bob also points his AR terminal 100B in direction of the table 210, but since he is positioned on the opposite side of Alice, he is looking at the corner 240 of the table. All corners of the table are identical.

The elements 250A and 250B respectively shown in FIGS. 2B and 2C represent the screens of the AR terminals 100A and 100B and thus illustrate what both users are visualizing from the AR Scene. As shown in FIG. 2B, Alice sees a representation 210A of a fraction of the table 210, a representation 230A of the corner 230 and a representation 220A of the mug 220. In addition, a virtual object 270A is inserted into the picture representing an animated 3D model of a donut that bounces on the table (showing its happiness to encounter the mug!). On his side, as shown in FIG. 2C, Bob sees a representation 210B of a fraction of the table 210, a representation 240B of the corner 240 and a virtual object 270B representing the same animated 3D model of a donut that bounces on the table. However, Bob does not see on his screen the real mug 220 since this object is outside of his field of view. Therefore, the animation in this context has less sense and more importantly does not correspond to the expected augmented reality experience as it was defined in the AR scene.

The difference between users A and B is that the Alice is well positioned within the AR scene. More exactly, the position of the AR terminal 100A is correct while the position of the AR terminal 100B is incorrect. Indeed, the corner 230 corresponds to an anchor defined in the AR scene by Alice and used to position the virtual object 270. Bob is trying to visualize the anchor set by Alice. However, since the corners 230 and the corner 240 are very similar in shape and texture, they comprise very similar feature points and the positional tracking has some difficulties to differentiate them. Thus, Bob is believed to be at the same place than Alice, i.e. at the corner of the table where the mug is located. However, the animation shown to Bob is not as expected by the AR scene designer and should only be shown in proximity of the corner 230.

Although this example is a toy example for the sake of drawability of the associated figures, it illustrates the issue of erroneous positioning when using anchors. The situation can be much more complicated in a more realistic situation where the AR scene comprises dozens of virtual objects and the real environment comprises many physical elements such as furniture.

Embodiments described hereafter have been designed with the foregoing in mind.

In at least one embodiment, it is proposed to associate helper data to augmented reality anchors. Helper data may describe the surrounding of the anchor in the real environment and may allow to verify that positional tracking is correct, in other words, that an AR terminal is localized at the right place in an AR scene. This helper data may be shown on request of the user or the AR terminal or the AR controller in order to perform a verification. The disclosure uses an example of 2D image as helper data but other types of helper such as a 3D mesh or a map showing the position of the anchor within the environment can be used according the same principles.

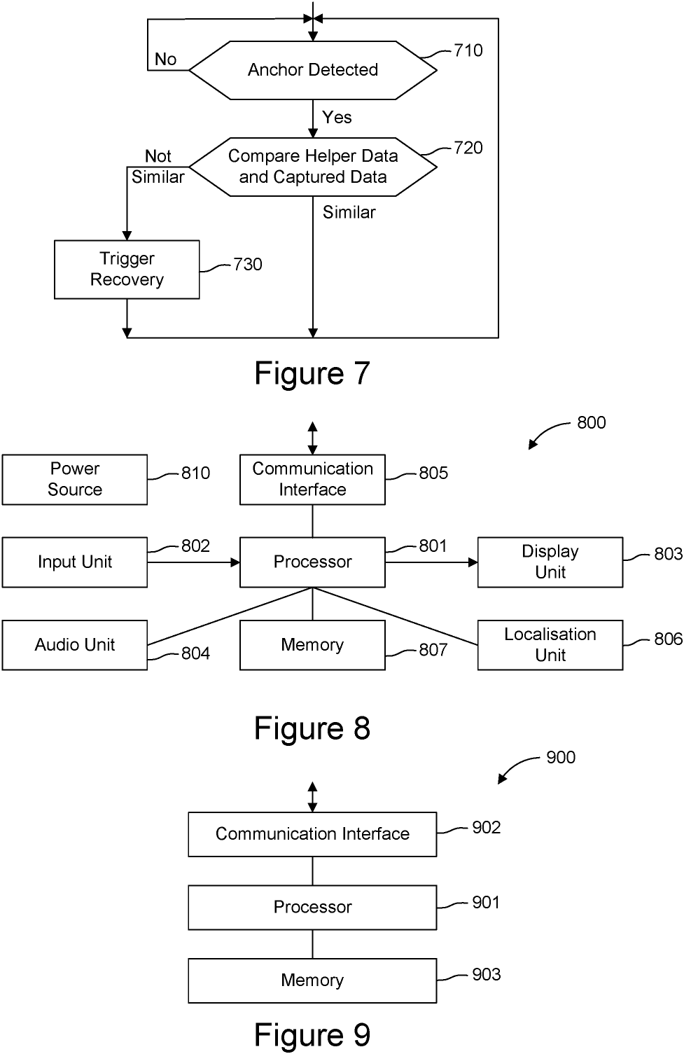

In at least one embodiment, the verification is done by the user. This requires that the helper data be understandable by the user. In at least one embodiment, the helper data is an image of the real environment captured when creating the anchor. Indeed, this is a data easy to capture and simply to understand for the user: he may simply compare visually the helper image with the real environment and decide if the positional tracking is correct. In another embodiment, the verification is done automatically by the AR system, as described further below with regards to FIG. 7.

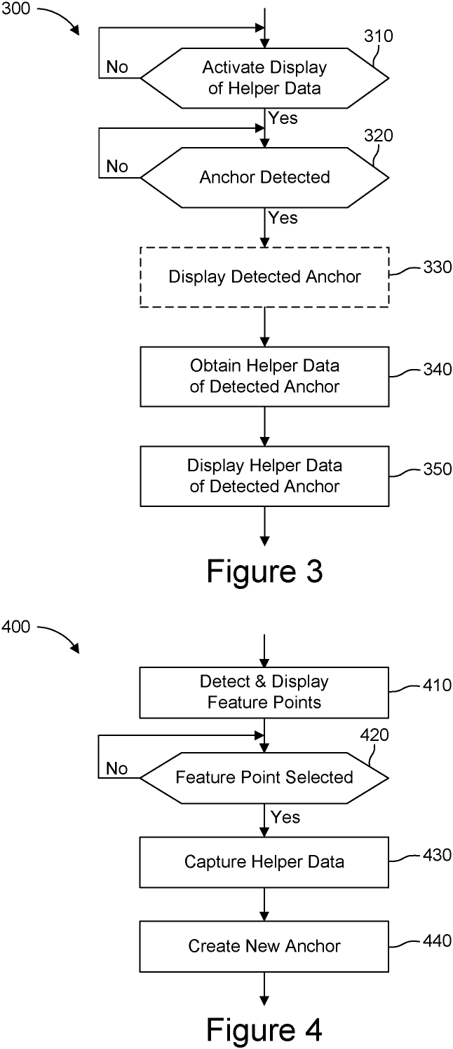

FIG. 3 illustrates an example flowchart of a user-operated verification process according to at least one embodiment. The verification process 300 may be executed by an AR terminal either alone or in combination with an AR controller. In step 310, a request for the activation of the display of helper data is detected. Then, in step 320, AR anchors are detected. When at least one anchor is detected, in step 330 a graphical element representing the anchor may be displayed. In embodiments, this step may be omitted. Then, in step 340, the helper data associated to the detected anchor is obtained and in step 350 a graphical representation of the helper data is displayed. In at least one embodiment, the order of steps 310 and 320 is reversed so that the activation of the display of helper data may be triggered when an anchor is detected.

Such verification process 300 can be requested either by the user himself, by the AR terminal or by the AR controller. A first reason for requesting a verification is when something is wrong within the AR scene or when virtual objects do not mix well with the real environment. A second reason is when the position of the virtual objects to append to the real environment do not comply with the captured environment. A third reason is when the position of an AR terminal is incoherent, for example multiple AR terminal are detected to have the same position in the real environment, an AR terminal is detected as being inside an object (i.e. behind the surface of the mesh).

FIG. 4 illustrates an example flowchart of process for the creation of an anchor according to at least one embodiment. The process 400 may be executed by an AR terminal either alone or in combination with an AR controller. In step 410, the feature points of the scene are detected and displayed on the screen of the AR terminal. In step 420, one of the feature point is selected to become an anchor. In step 430, helper data is captured and in step 440 the new anchor is created. The helper data as well as data representative of parameters of the selected feature point such as its location and signature are associated to the anchor. The anchor may then be stored with the AR scene by the AR controller.

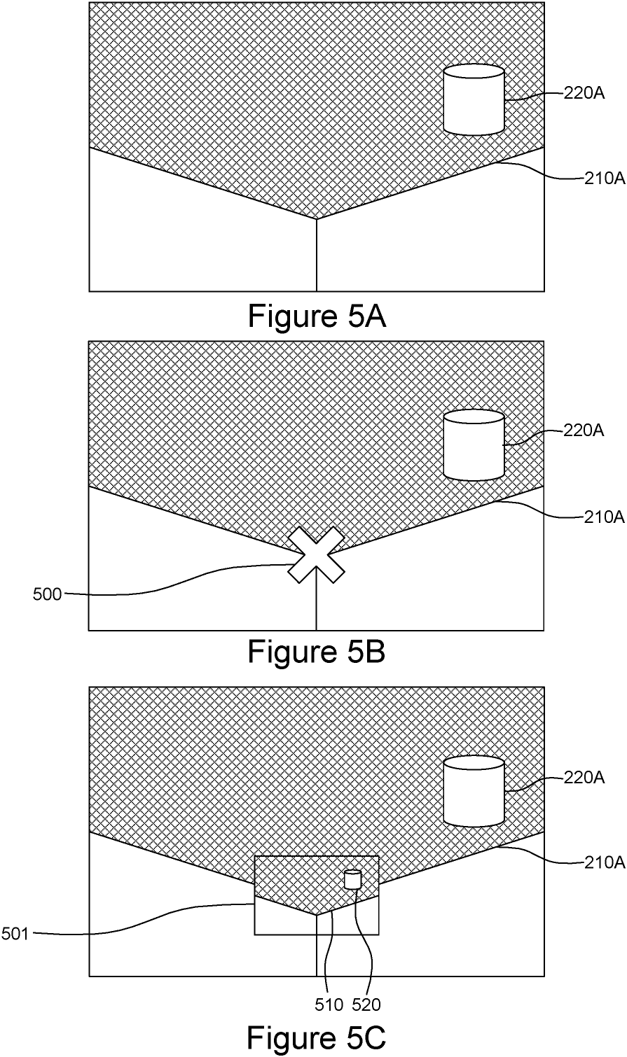

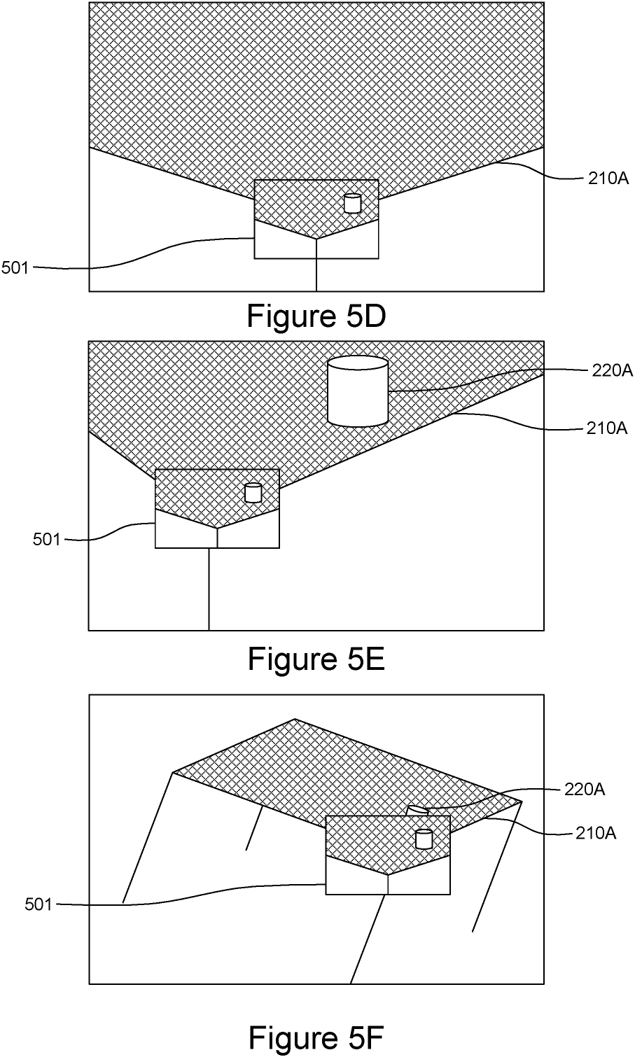

FIGS. 5A to 5E illustrate various examples of screens displayed by an AR terminal according to the verification process 300. In FIG. 5A, the AR terminal shows a representation of the table 210A and of the mug 220A, as captured by Alice’s AR terminal 100A. FIG. 5B shows the screen displayed when the activation of the display of helper data is has been activated (step 310 of process 300) and when an anchor is detected (step 320 of process 320). Here the white cross 500 represents the anchor that corresponds to the corner 230 of the table 210A. In a language abuse, this anchor will be identified hereafter as anchor 500. As previously mentioned, this display step is optional. FIG. 5C shows the display of the helper data under the form of a helper image 501.

In at least one embodiment, the helper data is a 2D image of the surroundings of the anchor 500. This 2D image was captured at the creation of the anchor thanks to the built-in camera of the AR terminal. Therefore, the helper image 501 comprises a representation 510 of the table 210 and a representation 520 of the mug 220. These representations allow an easy verification by the user: Alice can simply check that the helper image 501 corresponds to the capture of the real environment (as shown in FIG. 5A). Optionally, a button or icon allows Alice to toggle very quickly between a state where the helper image is displayed and another state where the helper image is not displayed (thus acting on the test of step 310 of process 300). Some image processing may be performed to transform the captured image into helper data. A first example is cropping the image to limit the image content to the surroundings of the anchor and not the whole scene. Cropping also allows to visualize the surroundings of the anchor and thus allows the positioning. The cropping is preferably done at a common predetermined size so that all helper images have the same size to ensure consistency of the user experience. Other examples of image processing comprise reducing the resolution (for example using well known sub-sampling techniques to reduce the spatial resolution of the captured image) or reducing the color space (for example using well known color space reduction techniques on the captured image to transform a 24-bit color space image into an image in a smaller color space) in order to reduce the memory requirements for storage of the helper data. All these image processing techniques may be applied together to the captured image to generate a helper image.

In another example embodiment not illustrated, the helper data is a 3D mesh of the surroundings of the anchor. Such mesh may be reconstructed by using depth information captured by a depth sensor integrated into the AR terminal or by using other 3D reconstruction techniques for example based on Structure From Motion (SFM) or Multi-View Stereo (MVS). In addition, the mesh may also be textured using information from the 2D image captured by the camera and thus represents a virtual 3D surrounding of the anchor. In this case, the helper data is a 3D textured mesh.

While FIG. 5C showed the screen of Alice’s AR terminal, FIG. 5D shows the screen of Bob’s AR terminal. Since the opposite corners of the table are very similar, the signature of the detected feature points near the corner 240 matches the signature of the feature points of anchor 500. Thus, the AR terminal decide to have detected this anchor and, when the verification is activated, displays the helper image 501 associated to the anchor 500. In this case, Bob immediately understands that he is not positioned at the right place of the real environment and has to move to a corner where there is a mug nearby.

In such situation, Bob could simply move around, hoping that the AR system will correctly detect his position. In some situations, he may be obliged to manually force a reset of his localization or even to relaunch the AR application

While FIG. 5C showed the screen of Alice’s AR terminal at the same position that when creating the anchor, FIG. 5E shows the same screen after Alice moved around the table in a anti-clockwise direction. Thus, since the anchor 500 is detected, its associated helper image is shown. Although Alice’s current viewing angle is different from the one used at the capture of the helper image 501, she understands easily that she is positioned at the right place. FIG. 5F show a similar situation after Alice moved back several feet so that she sees nearly the whole table. Again, the verification is very easy in such case.

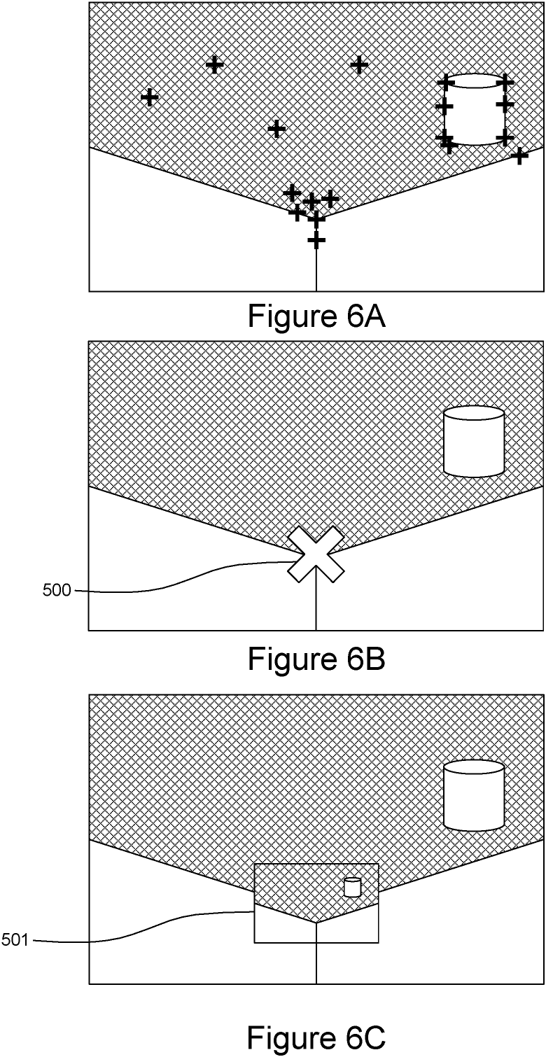

FIGS. 6A, 6B, 6C illustrate various examples of screens displayed by an AR terminal according to the anchor creation process 400. Prior to these figures, the AR terminal is set into a mode for creating the anchors. In FIG. 6A, the AR terminal displays the feature points that are detected by the AR system, in step 410 of process 400. The feature points are represented here by black crosses. Once the user selects one of them as being the anchor (step 420 of process 400), the AR terminal displays the anchor 500 at the location of the selected feature point, as shown in FIG. 6B. Then the AR terminal captures the helper data (step 430 of process 400) which in one example embodiment is a cropped version of an image captured by the camera. The helper image 501 associated to the anchor 500 is then displayed as shown in FIG. 6C.

In at least one embodiment, the verification is done automatically by the AR system by computing a distance between the real environment and the helper image. When the distance is smaller than a threshold, the AR system determines that the position is correct and does not interrupt the user experience. The comparison may be done for example at the 2D image level using conventional image processing techniques and algorithms. The comparison may also be done in the 3D space when depth information is available, and the helper data contains such information.

FIG. 7 illustrates an example flowchart of an automated verification process according to at least one embodiment. The verification process may be executed by an AR terminal either alone or in combination with an AR controller. This verification is an alternative to the user operated verification process 300 and can take place silently while the user is displaying the AR scene. First, feature points are detected while displaying an AR scene and it is detected in step 710 when an anchor corresponds to one of the feature points. In this case, in step 720, the helper data associated to the detected anchor is compared with capture data representing the real environment. For example, a distance may be computed between the helper data and the captured data. A similarity is found when the distance is lower than a value. When no similarity is found, then a recovery is triggered in step 730. Such recovery may comprise alerting the user through a message, alerting the AR controller so that the AR application may be adapted to this bas positioning, requesting to reset the positional tracking system or relocating the anchor to the position detected in step 710. All these alternatives may also be provided to the user, allowing to choose the best recovery according to the situation currently experienced in the AR scene.

When the helper data is a 2D image, the distance may be computed using well known algorithms. One embodiment uses a “Feature Detection” algorithm like those provided by OpenCv, (SURF for example). Features are computed for image provided with the anchor and for the current frame. Detection is followed by a matching process. To check the success of the operation, a distance criterion between descriptors is applied to the matched elements to filter the result. In an implementation, when the anchor is detected in the field of view of the AR device, the process described above is launched. Precision and recall parameters are evaluated, according to their values, the presence of the anchor can be validated in a first step.

In a second step, in the set of matched points, we look for the closest point of the center, get the correspondence in the current frame and use this point as the result of a ray casting. The distance between the feature point hit by the ray and the anchor is computed. Rotation is not evaluated in this case. A deviation of few centimeters will be accepted.

When the helper data is a 3D textured mesh, it would be possible to compute a distance in 3D space but although it is feasible, it would require heavy computations. Another more efficient way is to go through an intermediate step of 2D rendering. As the pose of the mesh is known (the same than the anchor), the mesh can be rendered from the point of view of the user. The result is a 2D picture. The process described above can be used again.

Other techniques for implementing the automated verification process may be used. For example, deep learning techniques could be used for that purpose, thus operating directly on the 2d images without requiring a feature extraction step.

In at least one embodiment, when the recovery chosen is to relocate the AR anchor, the other AR anchors are also relocated by computing the transform to relocate the original anchor position to its new position, and applying this transform to the other AR anchors. Since such modification may have a huge impact, particularly in a multi-user scenario, it is preferred that such operation must be confirmed by the user through a validation.

FIG. 8 illustrates a block diagram of an example implementation of augmented reality terminal according to an embodiment. Such apparatus corresponds to AR terminals 100A, 100B and100C. The AR terminal 800 may include a processor 801. The processor 801 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform signal decoding, data processing, power control, input/ output processing, and/or any other functionality that enables the AR terminal to operate in an augmented reality environment.

The processor 801 may be coupled to an input unit 802 configured to convey user interactions. Multiple types of inputs and modalities can be used for that purpose. Physical keypad or a touch sensitive surface are typical examples of input adapted to this usage although voice control could also be used. In addition, the input unit may also comprise a digital camera able to capture still picture or video that are essential for the AR experience.

The processor 801 may be coupled to a display unit 803 configured to output visual data to be displayed on a screen. Multiple types of displays can be used for that purpose such as a liquid crystal display (LCD) or organic light-emitting diode (OLED) display unit. The processor 801 may also be coupled to an audio unit 804 configured to render sound data to be converted into audio waves through an adapted transducer such as a loudspeaker for example.

The processor 801 may be coupled to a communication interface 805 configured to exchange data with external devices. The communication preferably uses a wireless communication standard to provide mobility of the AR terminal, such as LTE communications, Wi-Fi communications, and the like.

The processor 801 may be coupled to a localization unit 806 configured to localize the AR terminal within its environment. The localization unit may integrate a GPS chipset providing longitude and latitude position regarding the current location of the AR Terminal but also other motion sensors such as an accelerometer and/or an e-compass that provide localization services. It will be appreciated that the AR terminal may acquire location information by way of any suitable location-determination method while remaining consistent with an embodiment.

The processor 801 may access information from, and store data in, the memory 807, that may comprise multiple types of memory including random access memory (RAM), read-only memory (ROM), a hard disk, a subscriber identity module (SIM) card, a memory stick, a secure digital (SD) memory card, any other type of memory storage device. In other embodiments, the processor 801 may access information from, and store data in, memory that is not physically located on the AR terminal, such as on a server, a home computer or another device.

The processor 801 may receive power from the power source 210 and may be configured to distribute and/or control the power to the other components in the AR terminal 800. The power source 210 may be any suitable device for powering the AR terminal. As examples, the power source 210 may include one or more dry cell batteries (e.g., nickelcadmium (NiCd), nickel-zinc (NiZn), nickel metal hydride (NiMH), lithium-ion (Li-ion), and the like), solar cells, fuel cells, and the like.

While FIG. 8 depicts the processor 801 and the other elements 802 to 808 as separate components, it will be appreciated that these elements may be integrated together in an electronic package or chip. It will be appreciated that the AR Terminal 200 may include any sub-combination of the elements described herein while remaining consistent with an embodiment.

The processor 801 may further be coupled to other peripherals or units not depicted in FIG. 2 which may include one or more software and/or hardware modules that provide additional features, functionality and/or wired or wireless connectivity. For example, the peripherals may include sensors such as a universal serial bus (USB) port, a vibration device, a television transceiver, a hands free headset, a Bluetooth® module, a frequency modulated (FM) radio unit, a digital music player, a media player, a video game player module, an Internet browser, and the like.

As stated above, typical examples of AR terminal are smartphones, tablets, or see-through glasses. However, any device or composition of devices that provides similar functionalities can be used as AR terminal.

FIG. 9 illustrates a block diagram of an example implementation of augmented reality controller according to an embodiment. Such apparatus corresponds to AR controller 110. The AR controller 900 may include a processor 901. The processor 901 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform signal decoding, data processing, power control, input/ output processing, and/or any other functionality that enables the AR terminal to operate in an augmented reality environment.

The processor 901 may be coupled to a communication interface 902 configured to exchange data with external devices. The communication preferably uses a wireless communication standard to provide mobility of the AR controllers, such as LTE communications, Wi-Fi communications, and the like.

The processor 901 may access information from, and store data in, the memory 903, that may comprise multiple types of memory including random access memory (RAM), read-only memory (ROM), a hard disk, a subscriber identity module (SIM) card, a memory stick, a secure digital (SD) memory card, any other type of memory storage device. In other embodiments, the processor 901 may access information from, and store data in, memory that is not physically located on the AR controller, such as on a server, a home computer or another device. The memory 903 may store the AR scene

The processor 901 may further be coupled to other peripherals or units not depicted in FIG. 9 which may include one or more software and/or hardware modules that provide additional features, functionality and/or wired or wireless connectivity. For example, the peripherals may include keyboard, display, various interfaces such as a universal serial bus (USB) port, a Bluetooth® module, and the like.

It will be appreciated that the AR controller 110 may include any sub-combination of the elements described herein while remaining consistent with an embodiment.

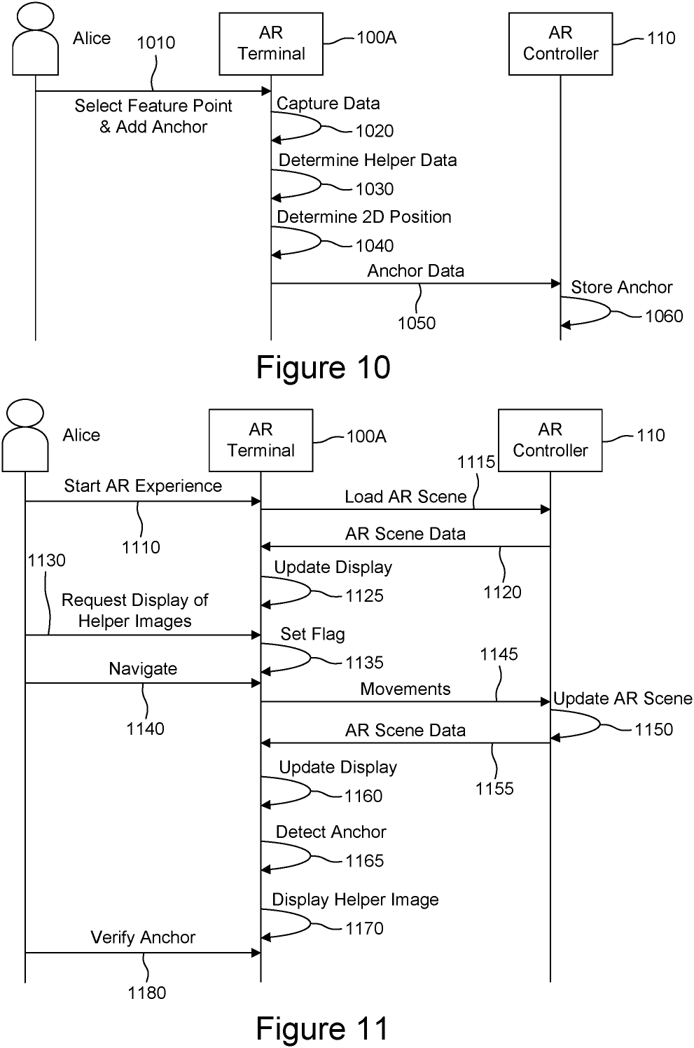

FIG. 10 illustrates a sequence diagram of an anchor creation according to at least one embodiment. The sequence diagram involves the user Alice operating her AR terminal 100A that interacts with the AR controller 110. The sequence diagram does not illustrate the prior interactions related to the AR scene loading, the positional tracking of the AR terminal, the navigation within the AR scene, since all these interactions are conventional and well known by the person skilled in the art. In step 1010, Alice selects a feature point and requests to add an anchor at the selected feature point. In step 1020, the AR terminal 100A captures data. As describe above the type data may be various. In this example, the helper data considered is a 2D image captured by the camera of the AR terminal. The helper data is determined in step 1030. In at least one embodiment, the helper data is obtained by cropping the captured image, for example by extracting a rectangular image of smaller size (for example 20% of the size of the capture image) centered on the position of the selected feature point. In addition, other image processing techniques can be applied such as reduction of the image resolution or of the color space. This allows to reduce the amount of data to be stored. The helper data and anchor parameters may be provided to the AR controller to be stored along with the AR scene. In embodiments, the size of the cropped image is comprised in a range of 5% to 35% of the size of the captured image. In an embodiment, the size of the helper image is fixed and determined as a parameter of the AR scene so that all AR Terminals generate helper images of identical size, independently of the capabilities of the camera of the AR terminal. In this case, this parameter is obtained in a former step by the AR terminal from the AR controller. In another embodiment, the AR terminal provides the full-size image as captured so that the helper image is done by the AR Controller.

Then, in step 1040, the 2D position of the anchor in the image is computed based on a pinhole camera model. To map a 3D point to the image plane, a camera projective model is used as follows:

$$s \left[\begin{matrix}u \\ v \\ 1\end{matrix}\right] = \left[\begin{matrix}{f}_{x} & 0 & {u}_{0} \\ 0 & {f}_{y} & {v}_{0} \\ 0 & 0 & 1\end{matrix}\right] \left[\begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix}\right] \left[\begin{matrix}X \\ Y \\ Z \\ 1\end{matrix}\right]$$

where:
the elements on the right side of the equal sign correspond to the projected point on image plane in pixel coordinate, with an aspect ratio scaling s that controls how pixels are scaled in the x and y direction as focal length changes
the first matrix on the right side of the equal sign is the camera intrinsic matrix K
the second matrix on the right side of the equal sign is the extrinsic parameters describing the relative transformation of the point in the world frame to the camera frame [R|t]
the third matrix on the right side of the equal sign represents the 3D point expressed in Euclidean coordinate system
In step 1050, the anchor data is provided by the AR terminal to the AR controller. The data comprises the anchor pose, the determined 2D anchor position, optionally the pose of the AR terminal, and the helper data (for example the helper image). In a variant embodiment, the anchor uses a set of feature points that forms a signature. In such embodiment, this data is also provided. Then, in step 1060, the anchor is stored by the AR controller in the AR scene 120.

FIG. 11 illustrates a sequence diagram of a manual verification according to at least one embodiment. The sequence diagram involves the user Alice operating her AR terminal 100A that interacts with the AR controller 110 on the AR scene 120. In step 1110, Alice requests to start the AR experience. In step 1115, the AR terminal requests to load the AR Scene 120. In response, the AR controller provides the AR Scene data in step 1120 so that the AR terminal can update the display in step 1125. Alice wants to verify her positioning within the AR scene. Thus, she requests to display the helper images in step 1130. The AR terminal sets a flag enabling such display in step 1135. Alice navigates within the AR scene in step 1140 and her movements are provided by the AR Terminal, in step 1145, to the AR controller which updates the AR scene accordingly, in step 1150 and sends back updated AR scene data in step 1155. The AR terminal updates the display according to the updated AR Scene data in step 1160. When an anchor is detected in step 1165, the helper image is displayed in step 1170 (since the flag is set), so that Alice can verify in step 1180 that the helper image corresponds to the current part of the scene she’s currently viewing.

In at least one embodiment, the display of the helper data is enhanced by using the pose of the corresponding anchor when available. In this case, the helper data is positioned in the 3D space according to the anchor’s pose. When the helper data is a 3D element, such as a 3D mesh or a full 3D model, the orientation of this 3D element will be set so that it matches the pose of the anchor. When the helper data is a 2D image, the 2D rectangle corresponding to the 2D image is warped so that it is positioned in a plane defined by the anchor’s pose.

In at least one embodiment, the helper image is displayed according to the viewer’s orientation so that it is facing the camera.

In at least one embodiment, the helper image is displayed as semi-transparency (using an alpha channel) in order to see “through” the helper to make the comparison easier.

In at least one embodiment, an AR terminal also includes the functionalities of an AR controller and thus allows standalone operation of an AR scene, while still being compatible with embodiments described herein.

Some AR systems balance the computation workload by performing some of the computations in the AR controller, that is typically a computer or server. This requires transmitting the information gathered from the AR terminal sensor to the AR controller.

In at least one embodiment, the pose of the AR Terminal (pose of the device when capturing the picture associated to the anchor) given by the server is also used. The user positions his camera as close as possible to the pose provided, but this only makes sense if there is no error.

An indication concerning the position of the anchor can be provided to the user so that he is moves into the right direction when no anchor is in her/his field of view.

In at least one embodiment, when multiple anchors are detected, both of them are displayed. In another embodiment, when multiple anchors are detected, only one of them is displayed. The selection of the anchor to be displayed may be done according to multiple criteria such as shortest distance, best matching viewing angle, etc.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, moving the information, copying the information, calculating the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory or optical media storage). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

1-27. (canceled)

28. A method comprising:
determining an augmented reality anchor corresponding to at least one feature point detected while displaying an augmented reality scene;
obtaining data associated with the detected augmented reality anchor, the data being an image based on a picture captured when creating the anchor;
obtaining captured data representative of a real-world scene; and
when an anchor is detected in the captured data representative of the real-world scene, determining a distance between features of the image and features of the captured data and responsively triggering a recovery when the features of the image and features of the captured data are not similar.

29. The method of claim 28, wherein the features of the image and the features of the captured data are considered similar when the distance is lower than a threshold value.

30. The method of claim 28, wherein the distance is determined based on the closest point of the center of matching points between the image and captured data.

31. The method of claim 28, wherein triggering the recovery comprises alerting the user through a message.

32. The method of claim 28, wherein triggering the recovery comprises:
alerting an augmented reality controller controlling an augmented reality application handling the augmented reality scene that a position parameter of the augmented reality application may be adapted.

33. The method of claim 28, wherein triggering the recovery comprises:
requesting to reset a positional tracking system that determines a position of an augmented reality controller controlling an augmented reality application handling the augmented reality scene.

34. The method of claim 28, wherein triggering the recovery comprises:
relocating the anchor to the position detected.

35. The method of claim 28, wherein triggering the recovery comprises:
alerting the user through a message;
alerting the augmented reality controller so that an augmented reality application handling the augmented reality scene may be adapted; and
requesting to reset the positional tracking system or relocating the anchor to the position detected.

36. The method of claim 28, wherein the data is a cropped version of the picture captured when creating the anchor or a processed version of the picture captured when creating the anchor with reduced spatial resolution or a processed version of the picture captured when creating the anchor with reduced color space or a cropped version and processed version with reduced spatial resolution or color space of the picture captured when creating the anchor or is based on a three-dimensional mesh captured when creating the anchor.

37. An augmented reality apparatus comprising a processor configured to:
determine an augmented reality anchor corresponding to at least one feature point detected while displaying an augmented reality scene;
obtain data associated with the detected augmented reality anchor, the data being an image based on a picture captured when creating the anchor;
obtain captured data representative of a real-world scene; and
when an anchor is detected in the captured data representative of the real-world scene, determine a distance between features of the image and features of the captured data and responsively trigger a recovery when features of the image and features of the captured data are not similar.

38. The apparatus of claim 37, wherein the features of the image and the features of the captured data are considered similar when the distance is lower than a threshold value.

39. The apparatus of claim 37, wherein the distance is determined based on the closest point of the center of matching points between the image and captured data.

40. The apparatus according to claim 37, wherein triggering the recovery comprises alerting the user through a message.

41. The apparatus of claim 37, wherein triggering the recovery comprises alerting an augmented reality controller controlling an augmented reality application handling the augmented reality scene that a position parameter of the augmented reality application may be adapted.

42. The apparatus of claim 37, wherein triggering the recovery comprises requesting to reset a positional tracking system that determines a position of an augmented reality controller controlling an augmented reality application handling the augmented reality scene.

43. The apparatus of claim 37, wherein triggering the recovery comprises relocating the anchor to the position detected.

44. The apparatus of claim 37, wherein triggering the recovery comprises:
alerting the user through a message;
alerting the augmented reality controller so that the augmented reality application handling the augmented reality scene may be adapted; and
requesting to reset the positional tracking system or relocating the anchor to the position detected.

45. The apparatus of claim 37, wherein the data is a cropped version of the picture captured when creating the anchor or a processed version of the picture captured when creating the anchor with reduced spatial resolution or a processed version of the picture captured when creating the anchor with reduced color space or a cropped version and processed version with reduced spatial resolution or color space of the picture captured when creating the anchor or is based on a three-dimensional mesh captured when creating the anchor.

46. A computer program comprising program code instructions for implementing the steps of a method according to claim 28 when executed by a processor.

47. A non-transitory computer readable medium comprising program code instructions for implementing the steps of a method according to claim 28 when executed by a processor.
